(19) United States
(12) Patent Application Publication
(10) Pub. No.: US 2021/0276236 A1
(43) Pub. Date: Sep. 9, 2021

(54) Apparatus for forming a protecting duct with integrated inner and outer walls, and the duct formed thereby

(71) Applicant: ITECO LTD., Seongnam-si Gyeonggi-do (KR)

(72) Inventor: Kyung Ro LEE, Seongnam-si Gyeonggi-do (KR)

(21) Appl. No.: 17/329,149

(22) Filed: May 25, 2021

Related U.S. Application Data
(63) Continuation of application No. PCT/KR2020/007689, filed on Jun. 15, 2020.

(30) Foreign Application Priority Data
Sep. 2, 2019 (KR) 10-2019-0108066

(51) Int. Cl. B29C 48/09; B29C 48/13

(52) U.S. Cl. CPC B29C 48/09; B29L 2023/186; B29C 48/13

(57) ABSTRACT

According to an embodiment of the present disclosure, a cylindrical sizing machine is located next to the inner-wall dice, which reduces the outer diameter of the inner wall to a desired length as it passes from the entry point into which the semi-solid inner wall is introduced to the end point; a coolant flow path, through which the coolant is supplied from an external source, is formed within the inner-wall dice and the inner-wall sizing machine; a guide support rod is installed, extending from the inner-wall dice to the inside of the outer-wall sizing machine; an inner-wall guide supported by the guide support rod is installed in the outer-wall sizing machine at the position where the shaping occurs: and the semi-solid inner wall passes between the inner-wall guide and the outer wall being shaped for tight integration with the outer wall by means of pressurization.

### TECHNICAL FIELD

The present invention relates to an apparatus for forming a protecting duct that is used to protect communication cables or power cables installed underground. In particular, the apparatus can manufacture a protecting duct with integrated inner and outer walls, which improves the forming speed and allows easy coiling while maintaining increased compressive strength.

### BACKGROUND ART

Various communication cables such as telephone cables and optical fiber cables, as well as power cables, are often buried underground due to consideration for urban landscape. When communication/power cables are installed underground, a protecting duct, w % here the cables are inserted, is used to protect them from harmful insects or flood damage.

Document 1 (Korea Patent No. 10-1454893) describes an apparatus for manufacturing an optical cable duct. In this apparatus, the 1st dice and the 2nd dice for extrusion molding of the inner and outer walls are located on both sides of the head dice, allowing the inner wall to be molded through the 1st dice of the 1^{st} extruder and the formed inner wall to pass through the 2nd dice of the 2nd extruder. At the same time, the outer wall is formed around the inner wall for integration of the both sides. In the apparatus of the Document 1, however, the cooling tank which cools the inner/outer walls is separately located on the outside of the dice. So, the molded inner/outer walls should be transferred to the cooling tank for cooling after passing through a sizing machine, which shapes the forms of the walls. This lowers cooling efficiency, and more time is required for cooling, delaying the whole manufacturing process.

Next, Document 2 (Korea Patent Publication No. 10-2015-0024538) describes a manufacturing apparatus for a cable duct, which is configured in a way that the 1st dice forming the inner wall lies upon the 2nd dice forming the outer wall. The inner surface of the inner wall is pressed by the pressing member to be in close contact with the outer wall. In the apparatus of the Document 2 the pressing member, which brings the inner wall in close contact with the outer wall, drives a pressing roll using a power transmission element, and this structure increases manufacturing and operating costs of the apparatus as well as complexity. In addition, while the outer wall is shaped spirally by a vacuum adsorption, the dimensions of the inner wall are not precisely controlled because there is no configuration for shaping the inner wall and the inner surface of the inner wall is pushed outward to be in close contact with the outer wall.

Meanwhile, previous apparatuses for forming protection ducts were not able to integrate the inner wall with the outer wall tightly, which lowered the compression strength of the formed duct. Furthermore, insufficient integration of the inner and outer walls made coiling of the duct difficult so that the protection duct was formed into a short length (for example, 6 meters) and then connected using an additional connecting accessory.

### DISCLOSURE

### Technical Problem

The objective of this invention is to solve the issues identified above by providing an apparatus for forming a protecting duct with integrated inner/outer walls, which can improve the compressive strength of the formed duct, increase the cooling efficiency as well as accuracy of the dimensions, and simplify the configuration of the apparatus so as to reduce manufacturing and operating costs.

In addition, this invention provides a protecting duct, in which the inner wall and the outer wall is tightly integrated, improving compressive strength significantly and allowing easy coiling for simple installation without an additional connection.

### Technical Solution

In an aspect, the present invention provides an apparatus for forming a protecting duct with integrated inner and outer walls comprising: an inner-wall dice for forming a semi-solid inner wall with molding resin; an outer-wall dice for forming a semi-solid, unshaped outer wall with molding resin around the outer circumferential surface of the semi-solid inner wall; the outer-wall sizing machine which allows the outer wall to be shaped around the outer circumferential surface of the inner wall as the semi-solid inner wall and unshaped semi-solid outer wall pass through the machine, wherein: a cylindrical sizing machine is located next to the inner-wall dice, which reduces the outer diameter of the inner wall to a desired length as it passes from the entry point (into which the semi-solid inner wall is introduced) to the end point, and a coolant flow path, through which coolant is supplied from an external source, is formed within the inner-wall dice and the inner-wall sizing machine; a guide support rod is installed, extending from the inner-wall dice to the inside of the outer-wall sizing machine in which an inner-wall guide supported by the guide support rod is installed at the position where the shaping occurs, and the semi-solid inner wall passes between the inner-wall guide and the outer wall being shaped for a tight integration with the outer wall by means of pressurization; and inside the outer-wall sizing machine is a cooling unit for cooling the inner wall and the protection duct integrated with the outer wall.

Regarding the present invention, the unshaped semi-solid outer wall passes through the outer-wall sizing machine in order to be shaped around the external circumferential surface of the inner wall, and the entry point of the mold is formed in a way that the unshaped semi-solid outer wall is introduced at an inclination angle of 20° with respect to the imaginary horizontal line at an intermediate depth of the crest and the valley corresponding to the crest and valley where the shaping occurs. In addition, half of the unshaped semi-solid outer wall moves to the outer surface of the entry point while the other half of the semi-solid outer wall moves to the inner surface of the entry point.

Regarding the present invention, the outer circumferential surface of the inner-wall guide is formed of a flat surface so that the inner circumferential surface of the inner wall can be formed of a flat surface.

Regarding the present invention, the outer circumferential surface of the inner-wall guide can be lined with plural V-shaped groove forming unit at regular intervals along the longitudinal direction of the inner wall so that the inner circumferential surface of the inner wall is lined with the plural V-shaped groove at regular intervals along the longitudinal direction of the inner wall.

This invention provides a protection duct with integrated inner and outer walls formed by the apparatus described above, wherein the inner wall has an outer circumferential surface made of a smooth duct while the outer wall is made of a corrugated duct having any one of trapezoidal, triangular, and semi-circular cross-sectional structures.

This invention provides a protection duct with integrated inner and outer walls formed by the apparatus described above, wherein the inner circumferential surface of the inner wall is lined with plural V-shaped groove at regular intervals along the longitudinal direction of the inner wall.

### Advantageous Effects

This invention configured as described above has the following effects.

First, the semi-solid inner wall is pressurized while passing through the outer wall being shaped and the inner-wall guide for an effective integration with the outer wall, and a space is formed between the inner wall (a smooth duct) and the outer wall (a corrugated duct), which can increase compressive strength.

Second, passing through the inner-wall sizing machine increases the accuracy of the inner diameter of the inner wall, and passing through the outer-wall sizing machine helps to shape the outer wall precisely, enhancing the dimensional accuracy of both the inner wall and outer wall.

Third, a coolant flow path formed inside the inner-wall dice and inner-wall sizing machine improves the cooling efficiency compared to the conventional apparatus, where the inner wall is cooled by a separate cooling tank, and reduces the process time by saving time required for cooling.

Forth, the configuration of the invention is much simpler compared with the conventional forming apparatus, reducing manufacturing cost and operating cost.

Fifth, the protection duct formed by the apparatus has no seam and can be coiled up to a length of 500 meters to 1000 meters and thus can be laid at once without using connecting members to link a large number of ducts.

### DESCRIPTION OF DRAWINGS

FIG. 1 is a diagram of an apparatus for forming the protection duct with integrated inner and outer walls based on the present invention.

FIG. 2 shows an enlarged view of the part where the outer wall is molded on the outer circumferential surface of the inner wall by the apparatus of the present invention.

FIG. 3 shows the inner-wall guide in the apparatus of the present invention.

FIG. 4 shows the inner-wall guide of another embodiment for the apparatus of the present invention.

FIG. 5 is a front view showing the structure of the protection duct molded at the inner-wall guide shown FIG. 3.

FIG. 6 is a front view showing the structure of the protection duct molded at the inner-wall guide shown FIG. 4.

FIG. 7 is a cross-sectional view showing a protection duct of the present invention to which the 1st embodiment of the outer wall is applied.

FIG. 8 is a cross-sectional view showing a protection duct of the present invention to which the 2nd embodiment of the outer wall is applied.

FIG. 9 is a cross-sectional view showing a protection duct of the present invention to which the 3rd embodiment of the outer wall is applied.

### MODE FOR INVENTION

Hereinafter, preferred embodiments of the present invention will be described in detail with reference to the accompanying drawings. However, the present invention may be modified in various different forms without being limited to the embodiments described below. The embodiments of the present invention are provided to help those skilled in the field to fully understand the invention.

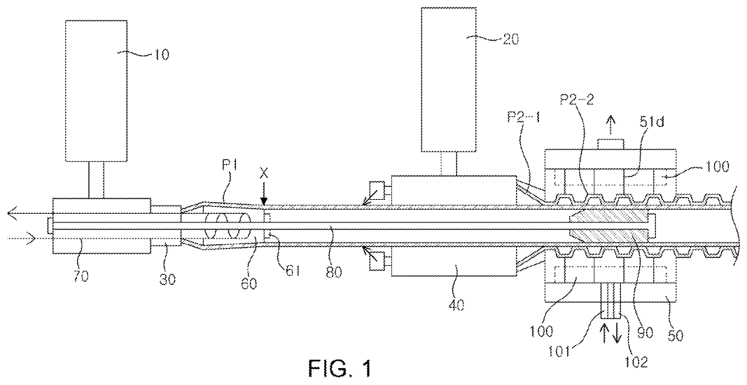

FIG. 1 shows the structure of the apparatus for forming a protecting duct with the integrated inner/outer walls. As shown in FIG. 1, the apparatus of the present invention includes an inner-wall resin extruder 10 for extruding the inner-wall molding resin and an outer-wall resin extruder 20 for extruding the outer-wall molding resin.

The inner-wall molding resin, extruded from the inner-wall resin extruder 10, is semi-solid resin and supplied to the inner-wall dice 30 for molding of the inner wall P1. The outer-wall molding resin, extruded from the outer-wall resin extruder 20, is also semi-solid resin and is supplied to the outer-wall dice 40 in order to form an unshaped outer wall P2-1.

The inner-wall dice 30, connected to the inner-wall resin extruder 10, allows the inner-wall molding resin to be formed into a semi-solid inner wall P1. The outer-wall dice 40, connected to outer-wall resin extruder 20, allows the outer-wall molding resin to be formed into a semi-solid unshaped outer wall P2-1 around the outer circumferential surface of the semi-solid inner wall P1.

In addition, the semi-solid inner wall P1 and semi-solid unshaped outer wall P2-1 pass through the outer-wall sizing machine 50 for the shaping of the outer wall P2-1 around the outer circumferential surface of the inner wall P1.

Although not shown in the Drawings, there is a capstan, designed to pull the completed inner and outer wall-integrated protection duct, next to the outer-wall sizing machine 50.

In addition to the configuration above, the apparatus of the inner/outer wall-integrated duct of the present invention has the following configuration.

First, the inner-wall sizing machine 60 is located next to the inner-wall dice 30 designed for precision of the inner diameter of the semi-solid inner wall P1. That is, the cylindrical sizing inner-wall sizing machine reduces the outer diameter of the semi-solid inner wall P1 to a desired length as it P1 passes from the entry point (into which the semi-solid inner wall is introduced) to the end point as shown in FIG. 1. Therefore, the inner diameter of the semi-solid inner wall P1, moving in contact with the outer circumferential surface of the inner-wall sizing machine 60, contracts by the decreasing outer diameter of the inner-wall sizing machine 60, which allows the final inner diameter to be determined at the end point of the inner-wall sizing machine 60, indicated as ‘X’ in FIG. 1. As a result, the inner wall P1 will have a uniform inner diameter after passing through the inner-wall sizing machine 60.

Next, there is a coolant flow path 70, through which the coolant is supplied from an external source, in the inner-wall dice 30 and the inner-wall sizing machine 60. The coolant flow path 70 receives cooling water from an external source (e.g., a coolant circulation pump) and circulates inside the inner-wall dice 30 and the inner-wall sizing machine 60, in order to cool the high-temperature inner-wall molding resin extruded from the inner-wall resin extruder 10 and keep the resin in the semisolid state. As a result, the coolant flow path 70 formed inside the inner-wall dice 30 and inner-wall sizing machine 60 improves the cooling efficiency compared to the conventional apparatus, where the inner wall is cooled by a separate cooling tank, and reduces the process time by saving time required for cooling.

Next, a guide support rod 80 is installed, extending from the inner-wall dice 30 to the inside of the outer-wall sizing machine 50. The guide support rod 80 is fixed to the inner-wall sizing machine 60 by the fastening nut 61, and the inner-wall guide 90 located inside the outer-wall sizing machine 50 is supported by the rod as well. That is, the inner-wall guide 90 is located inside the outer wall being shaped P2-2 within the outer-wall sizing machine. Therefore, the semi-solid inner wall P1 passes between the inner-wall guide 90 and the outer wall being shaped P2-2 for tight integration with the outer wall P2-2 by means of pressurization.

Next, inside the outer-wall sizing machine 50 there is a cooling unit 100 for cooling the inner/outer wall-integrated duct formed after passing through the outer-wall sizing machine 50. The cooling unit 100 has a coolant inlet 101 and a coolant outlet 102, and is connected to an external coolant source (not shown in the drawings) for circulation of the coolant.

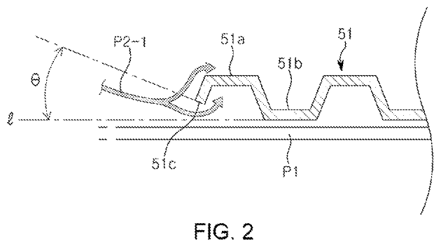

Meanwhile, the outer-wall sizing machine has an outer-wall shaping mold 51 (as shown in FIG. 2), which has vacuum slits 51d (See FIG. 1) connected to an external vacuum pump (not shown). Therefore, the outer wall being shaped by outer-wall sizing machine is formed to precise dimensions while being in close contact with the mold 51 by the negative pressure generated inside the outer-wall sizing machine 50 by the vacuum pump.

FIG. 2 shows an enlarged view of the part where the outer wall is molded on the outer circumferential surface of the inner wall by the apparatus of the present invention.

As shown in FIG. 2, the unshaped semi-solid outer wall P2-1 passes through the outer-wall sizing machine 50 in order to be shaped around the external circumferential surface of the inner wall P1, and the entry point 51c of the mold 51 is formed in a way that the unshaped semi-solid outer wall P2-4 is introduced at an inclination angle of 20° with respect to the imaginary horizontal line t at an intermediate depth of the crest 51a and the valley 51b corresponding to the crest and valley where the above-mentioned shaping occurs.

Furthermore, half of the unshaped semi-solid outer wall P2-1 moves to the outer surface of the entry point 51c while the other half of the semi-solid outer wall moves to the inner surface of the entry point 51c.

As a result, this unique design, allowing the semi-solid outer wall to be introduced at an inclination angle (0) of 20° in the entry point 51c and half of the unshaped semi-solid outer wall P2-1 to move toward the outer/inner surface of the entry point 51c respectively, makes it possible that the outer wall being shaped P2-2 within the outer-wall sizing machine 50 is formed to have a uniform thickness without variations between the inner surface and the outer surface.

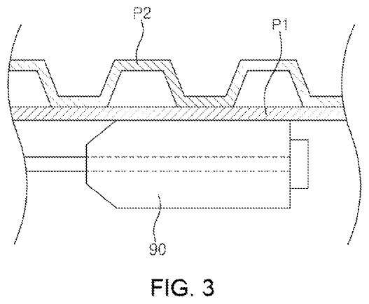

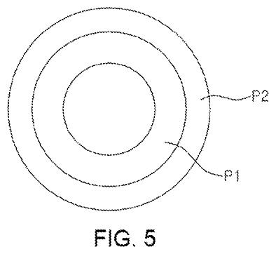

FIG. 3 shows the inner-wall guide in the forming apparatus of the present invention, and FIG. 5 is the front view showing the structure of the protection duct molded at the inner-wall guide shown FIG. 3. The outer circumferential surface of the inner-wall guide 90, depicted in FIG. 3, is made of a flat surface. As shown in FIG. 5, therefore, the inner wall P1 passing through the inner-wall guide 90 is formed inside the outer wall P2 in order to have the inner circumferential surface made of a flat surface.

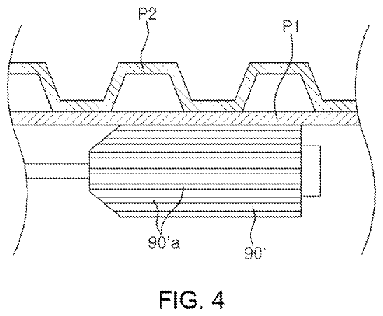

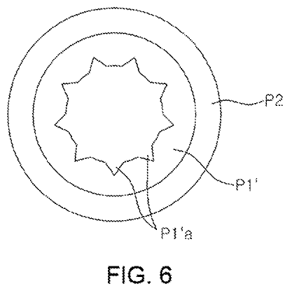

FIG. 4 shows the inner-wall guide of another embodiment for the apparatus of the present invention, and FIG. 6 is a front view showing the structure of the protection duct molded at the inner-wall guide shown FIG. 4. The outer circumferential surface of the inner-wall guide 90′, depicted in FIG. 4, is lined with plural V-shaped groove forming unit 90′a at regular intervals along the longitudinal direction of the inner wall P1. As shown in FIG. 6, therefore, the inner circumferential surface of the inner wall P1′ is lined with the plural V-shaped groove P1′a at regular intervals along the longitudinal direction of the inner wall P1′. In consequence, the inner wall P1′ with the V-shaped groove P1′a has a reduced frictional coefficient and can be easily installed with when communication line or power lines.

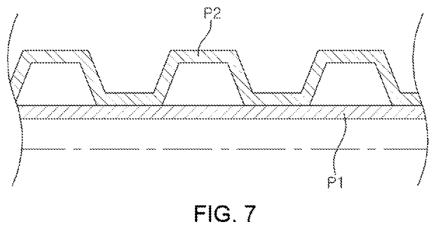

FIGS. 7 to 9 are cross-sectional views showing a protection duct of the present invention to which the 1st/2nd/3rd embodiment of the outer wall is applied.

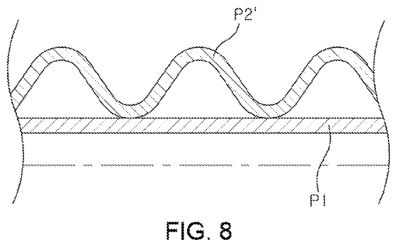

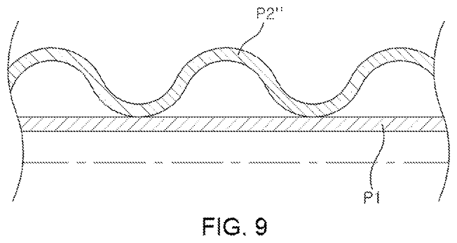

With respect to FIGS. 7 to 9, the inner wall P1 has an outer circumferential surface made of a smooth duct while the outer wall P2 of FIG. 7 is made of a corrugated duct having a trapezoidal cross-sectional structure, the outer wall P2′ of FIG. 8 is made of a corrugated duct having a triangular cross-sectional structure, and the one in FIG. 9 has a semi-circular cross-sectional structure.

Regarding the embodiments in FIGS. 7 to 9, the inner circumferential surface of the inner wall P1 consisting of a flat surface can be applied together as the inner wall P1 shown in FIG. 5, and the structure of the inner wall P1′ where the V-shaped groove P1′a is formed on the inner circumferential surface can be applied together just like the inner wall P1′ shown in FIG. 6.

As described above, the semi-solid inner wall is pressurized while passing through the outer wall being shaped and the inner-wall guide for effective integration with the outer wall, and also a space is formed between the inner wall (a smooth duct) and the outer wall (a corrugated duct), which can increase compressive strength.

In particular, the protection duct formed by the apparatus is featured by the tight integration of the outer and inner walls, and thus can be coiled up to a longer length (e.g. length of 500-1000 meters) compared to conventional ducts and can be laid at once without using connecting accessories to link a large number of ducts.

Although the preferred embodiments of the present invention have been disclosed for illustrative purposes, those skilled in the field will appreciate that various modifications, additions and substitutions are possible, without departing from the scope and spirit of the invention as disclosed in the accompanying claims.

What is claimed is:

1. An apparatus for forming a protecting duct with integrated inner and outer walls, comprising:
an inner-wall dice for forming a semi-solid inner wall with molding resin,
an outer-wall dice for forming a semi-solid, unshaped outer wall with molding resin around the outer circumferential surface of the semi-solid inner wall; and
an outer-wall sizing machine which allows the outer wall to be shaped around the outer circumferential surface of the inner wall as the semi-solid inner wall and unshaped semi-solid outer wall pass through the machine,
wherein a cylindrical sizing machine is located next to the inner-wall dice, which reduces the outer diameter of the inner wall to a desired length as it passes from the entry point, into which the semi-solid inner wall is introduced, to the end point, and a coolant flow path, through which the coolant is supplied from an external source, is formed within the inner-wall dice and the inner-wall sizing machine;
wherein a guide support rod is installed, extending from the inner-wall dice to the inside of the outer-wall sizing machine in which an inner-wall guide supported by the guide support rod is installed at the position where the shaping occurs within the outer wall, and the semi-solid inner wall passes between the inner-wall guide and the outer wall being shaped for tight integration with the outer wall by means of pressurization; and
wherein inside the outer-wall sizing machine is a cooling unit for cooling the inner wall and the protection duct integrated with the outer wall.

2. The apparatus for forming a protecting duct with integrated inner and outer walls of claim 1,
wherein the unshaped semi-solid outer wall passes through the outer-wall sizing machine in order to be shaped around the external circumferential surface of the inner wall; the entry point is formed in a way that the unshaped semi-solid outer wall is introduced at an inclination angle of 20° with respect to the imaginary horizontal line at an intermediate depth of the crest and the valley corresponding to the crest and valley where the shaping occurs; and
wherein half of the unshaped semi-solid outer wall moves to outer surface of the entry point while the other half of the semi-solid outer wall moves to the inner surface of the entry point.

3. The apparatus for forming a protecting duct with integrated inner and outer walls of claim 1, wherein the outer circumferential surface of the inner-wall guide is formed of a flat surface so that the inner circumferential surface of the inner wall can be formed of a flat surface.

4. The apparatus for forming a protecting duct with integrated inner and outer walls of claim 1, wherein the outer circumferential surface of the inner-wall guide is lined with plural V-shaped groove forming unit at regular intervals along the longitudinal direction of the inner wall so that the inner circumferential surface of the inner wall is lined with the plural V-shaped groove at regular intervals along the longitudinal direction of the inner wall.

5. The apparatus for forming a protecting duct with integrated inner and outer walls detailed on claim 1, wherein the inner wall has an outer circumferential surface made of a smooth duct while the outer wall is made of a corrugated duct having any of the following cross-sectional structures: trapezoidal, triangular, and semi-circular.

6. The apparatus for forming a protecting duct with integrated inner and outer walls of claim 5, wherein the inner circumferential surface of the inner wall is lined with plural V-shaped groove at regular intervals along the longitudinal direction of the inner wall.
